(19) United States
(12) Patent Application Publication
(10) Pub. No.: US 2010/0274666 A1
(43) Pub. Date: Oct. 28, 2010

(54) SYSTEM AND METHOD FOR SELECTING A MESSAGE TO PLAY FROM A PLAYLIST

(76) Inventors: Itzhak Wilf, Neve Monoson (IL); Oded Har-Tal, Beit Hashmonai (IL)

Correspondence Address: Pearl Cohen Zedek Latzer, LLP, 1500 Broadway, 12th Floor, New York, NY, 10036, US

(21) Appl. No.: 12/663,434

(22) PCT Filed: Jun. 5, 2008
(86) PCT No.: PCT/IL08/00775

§ 371 Date: Jul. 6, 2010

Related U.S. Application Data
(60) Provisional application No. 60/924,970, filed on Jun. 7, 2007.

(51) Int. Cl. G06Q 30/00

(52) U.S. Cl. 705/14.48; 705/14.52; 705/14.69

(57) ABSTRACT

A method for selecting at least one message from a playlist including a plurality of messages to be played by a message playing device to an exposed audience, each message directed to a target audience. The method comprises choosing a utility function, depending on one or more audience parameters, for each of the messages, periodically measuring the audience parameters pertaining to the exposed audience, calculating utility for each of the messages using the utility function, based on the audience parameters as periodically measured, and selecting a message to play from the playlist based on a cumulative gain attributed to each message from the playlist that has played, wherein the gain is updated with respect to the calculated utility for that message. Other methods and systems are also disclosed and claimed.

### FIELD OF THE INVENTION

The present invention relates to method and apparatus for presenting multimedia messages to an audience, and more particularly to a method of apparatus for selecting a message or a set of messages to play from a playlist of messages.

### BACKGROUND OF THE INVENTION

Messaging systems are used to deliver promotional or other information to an audience in a specific location. A visual messaging system may be, for example, a digital sign, computer or video display, or an LED message board. Sometimes an audio message accompanies the visual message as a sound track or an audio message plays without the visual message. Usually messages play in a preprogrammed manner (in many cases in a repeated loop). Alternatively, a message playlist is determined based on client demand and additional conditions and constraints, by external information systems in order to obtain optimal exposure of merchandise (goods and services) offered for sale. Alternatively, user actions may trigger message display modifying the predetermined order of messages.

In many applications better value of exposure can be derived if the messaging system is driven by information about the audience in the effective audience range of the messaging system. Such information may include audience size, gender, age, demographics, etc. Several methods have been proposed in the art to control multimedia displays to address specific members of the audience with content suitable or targeted towards such specific members.

Ismail, et al. (U.S. Pat. No. 7,146,627) describe a system residing preferably in a television set-top box monitors the television watching habits of one or more viewers and creates one or more profiles for each viewers descriptive of various characteristics of each viewers, including television watching preferences and demographics. The set-top box is able to select among various available video programming segments to create customized and/or targeted video programs for delivery to the viewer or viewers as a linear program. The customized linear video programs may include targeted content, advertising, and other video programming.

Collaborative subjects may wear identification means such as RFID (radio-frequency Identification) tags, Bluetooth devices, etc. If registered and profiled in advance, such data may be collected by suitable receivers in the area and used to drive the messaging system. Bermel (U.S. Pat. No. 6,674,357) describes a display device adapted to provide a display of advertising or other information messages targeted to persons in the vicinity of the display device, with a controller that communicates with at least one of a plurality of electronic cards in the possession of persons in the vicinity of the display device. Each such card stores information regarding the person associated with the electronic card. A communicator receives signals from the electronic cards in the vicinity of the display device and communicates with a central computer that selects advertising and other information messages based on the information about the person. The central computer communicates the selected advertisements to the display device for display to the person in the vicinity of the display device.

Shand (U.S. Patent Application Publication No. 2003/0126013) describes a viewer-targeted display system and method using at least one sensor for determining features of a subset of the plurality of viewers, including a visual sensor for determining one or more physical features of the viewers, or an audio sensor for determining one or more audible features of the subset. The system further includes a database of information files, where each information file is targeted to at least one class of viewers associated with at least one physical feature or audible feature. An information file selection module selects one or more information files to display on the information display, based upon at least one determined feature of the subset of the plurality of viewers.

Prior art methods do not teach how to adapt the displayed messages to the current viewers, in a variety of real-world situations, some of which are described herein by way of example:

In one real world situation, the set of messages may include a plurality of different messages that address the same target audience demographically, such as, for example, women, or children, etc. When such audience faces the display, current art does not teach how to select different messages from those of similar or identical value.

In another real-world situation, the number of viewers watching a specific message may be highly variable, so that at one instance there may be, for example, two children watching the display and at another instance some fifteen children. Prior art does not teach how to balance viewership among different messages.

In yet another real-world situation, the advertiser may designate one or more demographic target audience as qualified viewers for a message and agree to pay a certain fee related to the actual number of qualified viewers who are exposed to his messages. In yet another real-world situation said budget is subjected to a specific limit.

In another real-world situation, the network is obligated, for example, by contract, to play a certain message a fixed number or at least a number of times in a time period, such as a work day, and the all the above must satisfy such contractual obligations.

Prior art does not teach how to manage multiple different messages, each characterized by different target audiences, to display on one or more screens, possible subject to budget limitations, minimum frequency obligations and other constraints.

### SUMMARY OF THE INVENTION

There is thus provided, in accordance with some embodiments of the present invention, a method for selecting at least one message from a playlist including a plurality of messages to be played by a message playing device to an exposed audience, each message directed to a target audience, the method comprising:

choosing a utility function, depending on one or more audience parameters, for each of the plurality of messages;

periodically measuring said one or more audience parameters pertaining to the exposed audience;

calculating utility for each of the messages from the playlist using the utility function, based on said one or more audience parameters as periodically measured; and

selecting a message to play from the playlist based on a cumulative gain attributed to each message from the playlist that has played, wherein the gain is updated with respect to the calculated utility for that message.

Furthermore, in accordance with some embodiments of the present invention, the step of selecting a message to play from the playlist is also based on the calculated utility for each of the messages from the playlist.

Furthermore, in accordance with some embodiments of the present invention, the gain is calculated with respect to one ore more parameters selected from a group of parameters including: count of members of the exposed audience, count of select members of the exposed audience, exposure time of a message from the playlist to members of the exposed audience, exposure time of a message from the playlist to select members of the exposed audience, financial revenue obtained for playing a message from the playlist.

Furthermore, in accordance with some embodiments of the present invention, the utility function depends on one or more parameters selected from a group of parameters including: count of members of the exposed audience, count of select members of the exposed audience, exposure time of a message from the plurality of messages to members of the exposed audience, exposure time of a message from the plurality of messages to select members of the exposed audience, distance of members of the audience from the message playing device, financial revenue obtained for playing a message from the plurality of messages.

Furthermore, in accordance with some embodiments of the present invention, a message from the plurality of messages that has played is ignored for a predetermined duration of time when performing the step of selecting the message to play.

Furthermore, in accordance with some embodiments of the present invention, the step of selecting the message to play comprises selecting a message for which the cumulative gain is smaller than the cumulative gain of other messages from the playlist.

Furthermore, in accordance with some embodiments of the present invention, the step of selecting the message to play comprises selecting a message for which the cumulative gain is the smallest of the cumulative gain of other messages from the playlist.

Furthermore, in accordance with some embodiments of the present invention, the step of selecting the message to play comprises selecting a message for which the utility is greater than zero.

Furthermore, in accordance with some embodiments of the present invention, the step of selecting the message to play comprises selecting a message for which the utility is greatest.

Furthermore, in accordance with some embodiments of the present invention, said one or more measured audience parameters pertaining to the exposed audience are indicative of presence of at least a predetermined percentage of the target audience in the exposed audience.

Furthermore, in accordance with some embodiments of the present invention, the method further comprises playing additional content interleaved between played messages from the playlist.

Furthermore in accordance with some embodiments of the present invention, the method further comprises playing additional content and messages from the playlist concurrently.

Furthermore, in accordance with some embodiments of the present invention, the method further comprises ignoring a message from the playlist for which a predetermined budget has been consumed in the step of selecting the message to play.

Furthermore, in accordance with some embodiments of the present invention, there is provided a system for selecting at least one message from a playlist including a plurality of messages to be played by a message playing device to an exposed audience, each message directed to a target audience, the system comprising:

an input interface for choosing a utility function, depending on one or more audience parameters, for each of the plurality of messages; an audience tracker for periodically measuring said one or more audience parameters pertaining to the exposed audience; and a processor for calculating utility for each of the messages from the playlist using the utility function, based on said one or more audience parameters as periodically measured, and for selecting a message to play from the playlist based on a cumulative gain attributed to each message from the playlist that has played, wherein the gain is updated with respect to the calculated utility for that message.

Furthermore, in accordance with some embodiments of the present invention, the audience tracker comprises an imaging device.

Furthermore, in accordance with some embodiments of the present invention, the system comprises a budget manager module to issue a clear command allowing playing of a message from the playlist if a budget was confirmed and a halt command preventing playing of a message if the budget was consumed.

Furthermore, in accordance with some embodiments of the present invention, the system comprises a billing module.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 illustrates a multimedia display system according to the prior art;

FIG. 2 illustrates an audience measurement system that may be used in accordance with methods according to the present invention;

FIG. 3 is a functional diagram of a video-based audience tracker that may be used in accordance with methods according to the present invention;

FIG. 4 illustrates an audience-adaptive message rescheduling system according to embodiments of the present invention;

FIG. 5 is a flow-chart of a method for rescheduling playback of messages from a master playlist, based on minimum number of viewers according to embodiments of the present invention;

FIG. 6 is a flow chart of another method for rescheduling playback of messages from a master playlist, based on defining specific target audience according to embodiments of the present invention;

FIG. 7 is a flow chart of another algorithm for rescheduling playback of messages. from a master playlist, subject to minimum gap constraints according to embodiments of the present invention;

FIG. 8 is a flow chart of another method for rescheduling message playback, for increasing display effectiveness by selecting the message with largest utility according to embodiments of the present invention;

FIG. 9 is a flow chart of another method for rescheduling message playback that balances between the display effectiveness in terms of the number of qualified viewers addressed and the messaging effectiveness in terms of number qualified viewers addressed per message according to embodiments of the present invention;

FIG. 10 is a flow chart of a method for interleaving of messages from the master play-list and live television content according to embodiments of the present invention;

FIG. 11 illustrates a system for budget management of audience-adaptive message display according to embodiments of the present invention; and

FIG. 12 describes a method for budget-limited audience adaptive rescheduling algorithm according to embodiments of the present invention.

### DETAILED DESCRIPTION OF PREFERRED EMBODIMENTS

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing,” “computing,” “calculating,” “determining,” “selecting,” “choosing” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

The present invention may be used in a variety of applications. Although the present invention is not limited in this respect, the schematic diagrams and techniques disclosed herein may be used in many apparatuses such as personal computers (PCs), wireless devices or stations, video or digital game devices or systems, image collection systems, processing systems, visualizing or display systems, digital display systems, communication systems, and the like.

The present invention relates to a method and system for controlling the display of a set of multiple messages, for example, typically advertisements and informational messages, on a display screen in order to optimize the number of qualified viewers exposed to at least a subset of the set of multiple messages. By “qualified viewers” is meant any viewer from a viewer group who is the target for a particular message or a set of messages.

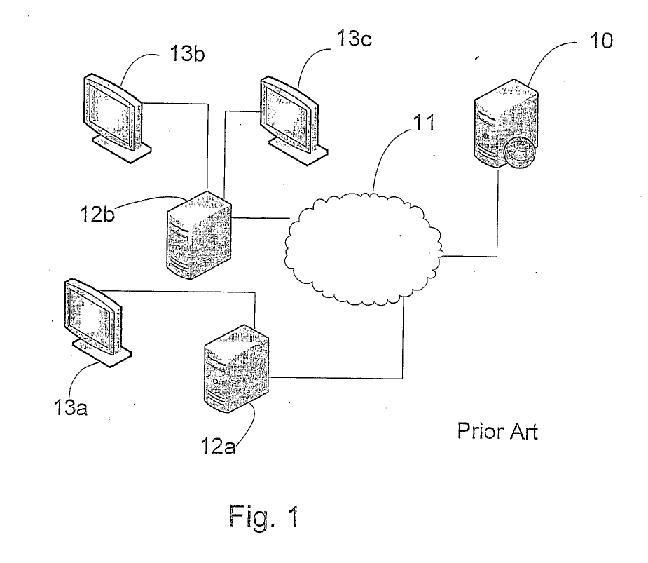

Reference is made to FIG. 1, which depicts a content management server 10 that uploads media to and controls one or more players 12a, 12b, via a communications network 11. The communication network 11 may be a local area network (LAN) or a wide area network (WAN). The display system comprises media players 12a, 12b, equipped with video display hardware capable of driving one or more displays 13a, 13b and 13c in order to display informational, advertising messages and other content.

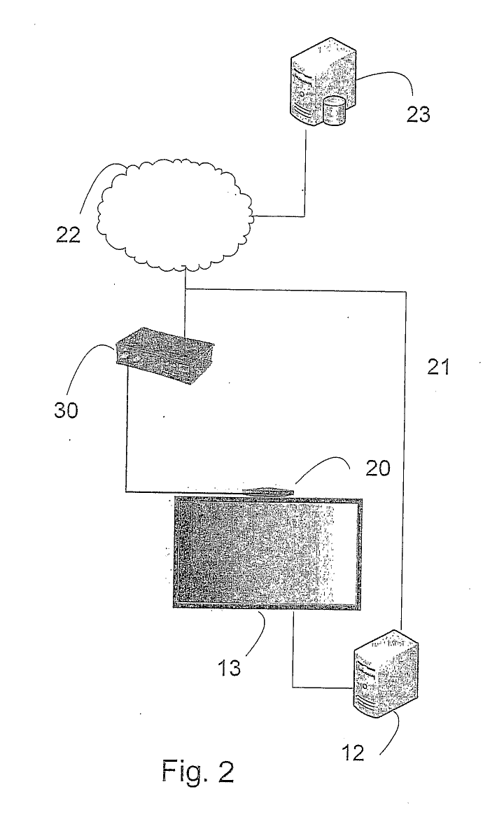

An audience measurement system, such as, for example, described in PCT/IL2008/000569 (not published yet), counts viewers, measures indicators of exposure and demographics for each viewer, as may be required for the purposes of embodiments of the present invention. For each measured screen, the associated audience measurement system comprises a camera 20 (see FIG. 2) that is placed on top of the display 13, driven by the media player 12. A video processor 30 is connected to camera 20, and executes video analysis algorithms for real-time audience measurement. The video processor is connected to a database and server 23 that stores the audience measurement data, directly or via a communications network 22. The communication network may be a local area network (LAN) or a wide area network (WAN). Specifically, local area network 21 connects between media player 12 and video processor 30 in order to relate audience measurement data to a play log maintained by the player. Users may access server 23 over LAN/WAN and produce content-based reports.

The field of face detection focuses on identifying face-like image regions based on pictorial characteristics. Specifically, a prior art method by Viola and Jones (Paul Viola and Michael Jones, “Rapid object detection using a boosted cascade of simple features”, in CVPR-IEEE Computer Society Conference on Computer Vision and Pattern Recognition, 2001) introduced a machine learning approach for visual object detection which is capable of processing images extremely rapidly and achieving high detection rates. Using a new image representation called the “Integral Image”, the features that may be used by the face detector can be computed very quickly. A learning algorithm, based on “AdaBoost” selects a small number of critical visual features from a larger set and yields extremely efficient classifiers. Finally, a method for combining increasingly more complex classifiers in a “cascade” allows background regions of the image to be quickly discarded while spending more computation on promising object-like regions.

Face tracking is a process of following face images from one video image to a subsequent image, captured by the same camera. The process of following may be used to count the number of different viewers, estimate exposure time, and optionally filter spurious exposures that may be associated with random glances, or false face detections. Face tracking may also be used to analyze viewer motion and smooth estimates of audience characteristics such as demographics by using multiple such estimates.

The concept of object tracking in video images is widely known in prior art. As one example, Froba and Kublbeck (Bernhard Froba and Christian Kublbeck, “Face tracking by means of continuous detection,” in Proc. of CVPR Workshop on Face Processing in Video (FPIV'04), Washington D.C., 2004) describe a method of face tracking by means of continuous detection, relying on fast methods such as the one described by Viola and Jones and using a Kalman filter to estimate the optimal state of a tracked face from the detection results.

Further analysis of facial images in order to determine facial pose, viewer distance and other attributes may require a process of facial features localization process in order to find the exact image position (in pixels) of several facial features (e.g. eyes, eyebrows, nose tip, lip corners, chin and ears). Multiple techniques are known for facial feature localization. Some of these techniques are based on a programming a specific detector for each feature (e.g. eye detector, mouth detector). Wiskott et al (Wiskott, L., Fellous, J. M., Kruger, N., and von der Malsburg, C. (1999). Face recognition by elastic bunch graph matching. In Intelligent Biometric Techniques in Fingerprint and Face Recognition, eds. L. C. Jain et al., CRC Press, ISBN 0-8493-2055-0, Chapter 11, pp. 355-396, and also Laurenz Wiskott, Jean-Marc Fellous, Norbert Kruger, et al. Face Recognition by Elastic Bunch Graph Matching, Proc. 7th Intern. Conf. on Computer Analysis of Images and Patterns, CAIP'97, Kiel) teach how to build a generic detector for a specific feature from a set of sample images of same feature (for example multiple images of a left eye) and then locate the left eye in a facial image by searching for a maximum response of the detector. For the specific case of eye detection, the bright pupil technique described below, locates eyes with great precision.

According to embodiments of the present invention viewers are counted in order to manage the play of multiple messages. The notion of viewing may be, for example, associated with “Face Towards”: having the viewer face turned towards the display. Several ways of estimating the face pose are known. In particular, the decision whether or not the face is oriented towards the screen can be carried by number of methods including symmetry analysis, as the left side of the face image will exhibit a large degree of symmetry with the right side of the face. The medial line of the face image can be computed from the facial features located as described above, and used to divide the face into a left and right portion, prior to testing for symmetry. Alternatively, a pose classifier can be trained in a supervised manner, using multiple face images for each pre-defined orientation: left, middle and right. Multiple left or right pose classes can be selected for more accurate pose estimation and better testing of the “Face Towards” condition.

Another condition of interest in the field of audience measurement is “Eyes-On” (or “gaze estimation”): having the viewer eyes open and turned towards the display. In some audience measurement applications, “Eyes-On” is considered a stronger or more desired condition than “Face Towards”. Eyes-On detection may use prior art techniques of eye pupil detection in high resolution images and by tracking the pupil position within the eye image. Eyes-On detection may also use using prior art techniques of active illumination, also known as the “retro-reflection” effect, where a light-source is placed on-axis with the camera optical axis. The camera is then able to detect the light reflected from the interior of the eye, giving rise to a “bright pupil” effect, as described by Morimoto et al (C. Morimoto et al, Real-Time Detection of Eyes and Faces, Proc. Workshop. Perceptual User Interfaces, San Francisco, Nov. 1998).

As display size and message visual detail may limit effective viewership to one that is conducted close enough to the display, requiring the video-based audience tracker to estimate the distance of tracked viewers and then limit counting only for the audience distance range of interest, or weigh audience counts in a manner that otherwise depends on viewer distance.

Camera parameters, together with the facial features locations, may be used to calculate the distance of the face from the camera, for example, using prior information about the distribution of the size of the facial feature in the entire population. One such measure can be the distance between the eyes. For that specific measure, the method for bright pupil detection provides a very accurate measure for such distance.

When the audience consists of different populations, for example children and adults, the distribution of face feature distances within these populations has to be accounted for, when estimating the face distance, as the average eyes distance of an adult is different from this of a young child. Face classification information as described below can be useful in deciding if the face under consideration belongs to an adult or to a child.

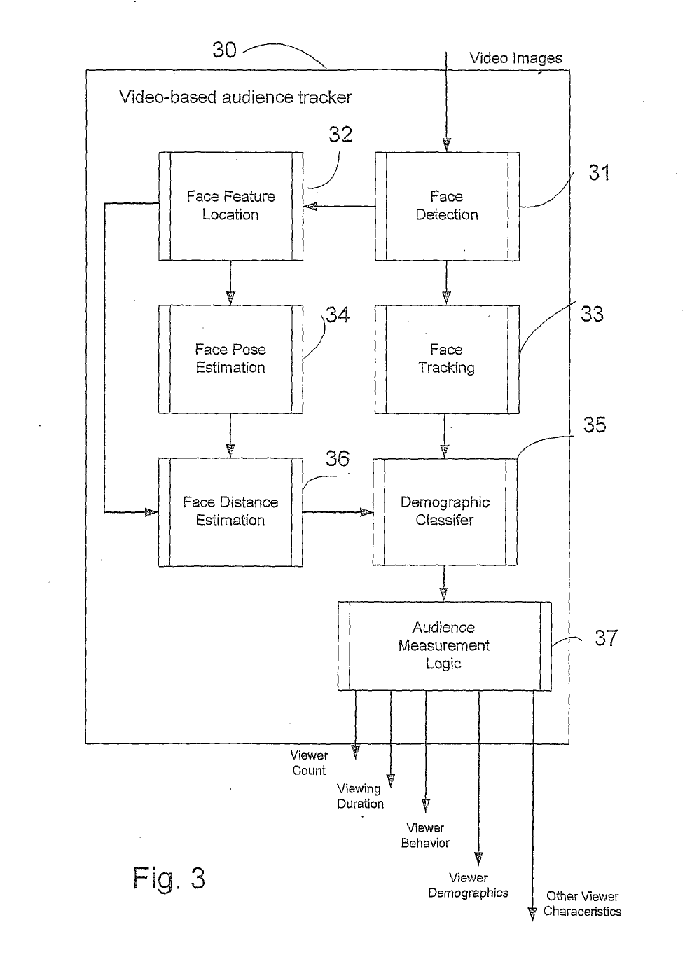

FIG. 3 is a functional diagram of a video-based audience tracker 30, which can be implemented using known techniques of face detection, face tracking, face distance and pose estimation and demographics classification using facial images. A video-based audience tracker 30 acquires images of the scene and the image data undergoes face detection 31. After face detection face tracking 33 may be performed, while concurrently or alternatively face feature location 32 may be performed, as well as face pose estimation 34 and face distance estimation 36. The processed information (which may include ID, location pose and distance) is passed through audience measurement logic 37, which may output viewer count, viewing duration, and viewer demographics. Other parameters and measurements such as viewer behavior, viewer clothing may be deduced from the image data as well.

An important parameter for audience-adaptive messaging is viewer demographics. By detecting the gender, age group and ethnicity for at least a subset of the set of current viewer, an appropriate message may be selected, based on the desired viewer demographics for that message and other constraints.

Sharma, et al. (US Patent Application publication No. 2003/001100038) describe a multi-modal system for determining the gender of a person using support vector machines (SVMs). Gender classification is first performed on visual (thumbnail frontal face) and audio (feature extracted from speech) data using support vector machines (SVMs). The decisions obtained from individual SVM-based gender classifiers are used as input to train a final classifier to decide the gender of an individual.

Face classifiers may be trained in similar manners to decide on age and ethnicity. Therefore, it is possible to characterize the target audience for specific messages in terms of a multi-dimensional audience vector, with dimensions of gender, age group and ethnicity or a subset thereof.

Additional visual information can be used to determine non-biometric characteristics. For example, viewers with eye glasses may be target audience for specific promotional messages. Viewers wearing sports apparel, optionally with specific brand or team logo may be a target audience for other promotional messages, etc.

All of the above described audience tracking and monitoring methods, as well as other audience tracking and monitoring methods can be used in conjunction with embodiments of the present invention, and are also incorporated herein by reference.

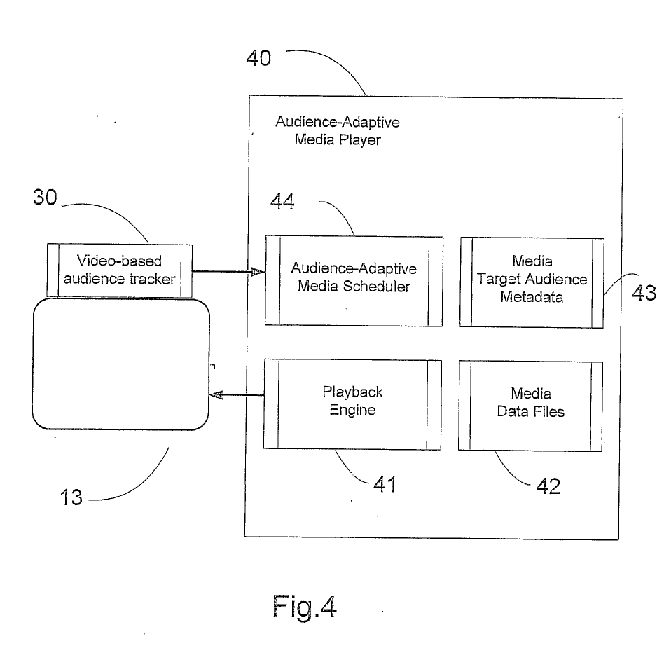

FIG. 4 illustrates an audience-adaptive message selection system according to embodiments of the present invention. The player 40 stores message data files 42, for example video or audio clips. When real-time audience data is not available, the messages are played in a predetermined sequence (e.g. a video loop), as defined by a master play list. To enable audience-adaptive playback, player 40 is connected to the video-based audience tracker 30, receiving real-time audience data, used by the audience-adaptive scheduler or selector 44 to select message for display in a manner that depends on current audience characteristic and target audience metadata 43, and thereby reschedule the original play list designed for that player.

Audience data can be easily represented by a scalar, relating to audience size which can be obtained from the number of current viewers, as determined by detecting and tracking facial images of the audience, and further determining if “Face Towards” or “Eyes On” conditions are satisfied. According to another embodiment of the present invention, facial images are further analyzed to for demographics and audience data comprises of audience vector. For example, in the case of classification into three (or other number of) age groups and gender, the audience vector may comprise of 6 (or other number of) values, one for each of the gender, age-group combinations: (male, young), (male, adult), (male, elder), (female, young), (female, adult), (female, elder). It will be understood that other classifications and/or categories may be used in place of or in addition to the above, and that the present invention is not limited to such classifications and/or categories.

The communication manner between the Player 40 and the Audience Tracker 30 may vary. According to one embodiment of the present invention, the Tracker may send the audience vector periodically, for example, at pre-programmed intervals (e.g. every 5 seconds), to the Player. Such method may be ineffective since vectors sent during playing of a message may be outdated when the message is over. Alternatively, the Player may receive the audience vector on demand only—for example a few seconds before the current playing of a message ends.

According to another embodiment of the present invention, the Tracker may be programmed to alert immediately upon the occurrence of certain events. As a specific example, when the number of viewers passes a certain high count threshold, the player may be programmed to terminate the current message and select a new message according to the present invention.

According to an embodiment of the present invention, real-time audience data used by the audience adaptive media scheduler includes audience size only. No information is provided in real-time about the audience demographics or alternatively, such information is ignored.

According to embodiments of the present invention “gain” may be determined with respect to the measured exposure of each of the messages with respect to a target audience to which the message is targeted.

In some embodiments of the present invention “gain” is measured in terms of counting the number of members of the audience that were exposed to a particular message.

In other embodiments of the present invention “gain” may be measured in terms of time of exposure, or selective count of only members of the audience who share a specific characteristics (for example, males or females only, certain age group, certain demographic group, and other groups of audience members of specific nature).

Other parameters may also be involved in determining the “gain”, such as, for example, financial revenue (e.g. billed charge or other consideration) obtained for playing a message or for achieving a predetermined goal, such as a predetermined agreed “gain”. “Gain” may be an accumulative parameter and may be measured for messages that have been played as time progresses, incremented each time the same message is played.

A utility function is chosen, corresponding to audience parameters per a given message, such as, for example, audience effective exposure time, number of viewers, type of viewers, gender of viewers, age of viewers, viewer demographics and other viewer related parameters.

The next message (or messages) to play is chosen based on the cumulative gain and on the utility calculated for messages in the playlist, based on available audience parameter (or parameters) as periodically obtained.

According to an embodiment of the present invention, audience size is quantized into at least two size levels. Pre-defined or user-define size thresholds are set between the size levels and a method of hysteresis is used to avoid fluctuation of the indicators when the audience size varies slightly.

According to an embodiment of the present invention, four-valued audience size indicators comprise of (ZERO, LOW, MED and HIGH) and set by specifying two threshold values LM and MH. Correspondingly, the audience size ranges are:

ZERO: 0; LOW [1, LM], MED: [LM +1, MH], HIGH: [MH +1, ∞]

For example, if LM=4 and MH=10, then an audience count <5 will generate a LOW value, audience counts between 5 and 10 will generate MEDIUM value and audience counts of 11 and up will generate HIGH value. Using a hysteresis value of 1, once the indicator changes from LOW to MED, audience size needs to be 3 or less to change back to LOW.

According to an embodiment of the present invention, size indicators are sensitive to all members of the audience within the measurement distance of the video-based audience tracker. According to another embodiment of the present invention, size indicators are sensitive to members of the audience that are close to the display as defined by a user-specified distance threshold which is applied to the Face Distance Estimation 36.

Size indicators may be used in simple content triggering applications such as triggering a key-message whenever the Audience size indicator is HIGH, or changing the display into touch-screen mode whenever the Near Audience size indicator is LOW.

According to another embodiment of the present invention real-time audience data includes at least audience counts, which allow the audience-adaptive media scheduler to reschedule media files or messages in order to achieve certain objectives.

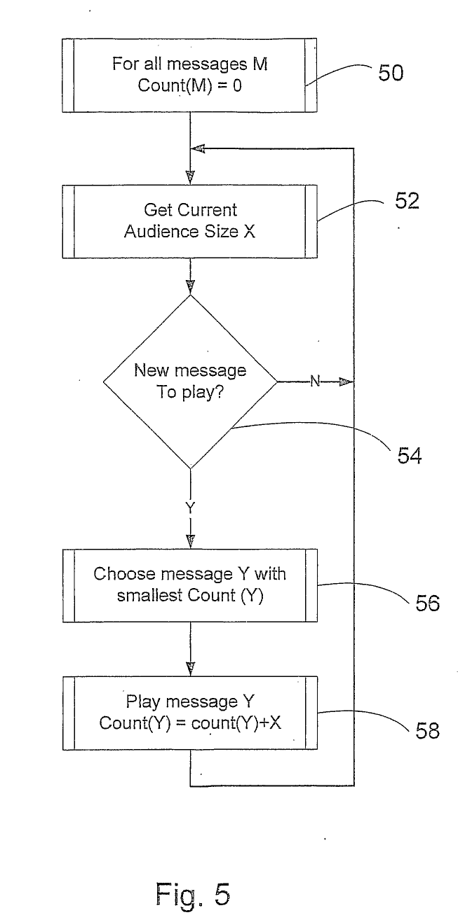

One such objective may be equalizing or balancing the number of potential viewers across at least of subset of the messages where the number of potential viewers is defined as the audience size prior to playing the message. FIG. 5 describes an algorithm that reschedules the playback of messages from the master playlist towards said equalization.

For each message Y in the play list, Count(Y) maintains the cumulative number of audience that was counted by the system, just before the message is played. At the beginning of a day (or any other initialization time which may be defined by the user), Count is reset for all messages (50). Then, whenever a new message is required for playing, the message selector queries for the audience size X (52), determines if a new message is to be played (54), chooses message Y such that Count(Y) is smallest (56) and plays it, now adding to the count the number X of viewers (58). In this specific embodiment, Count(Y) is the “gain” and the audience size X is the utility.

To prevent the contiguous play of the same message Y, as may be the case if count (Y) is much smaller than other messages and/or the current audience sizes X are small, a smallest time gap constraint is introduced.

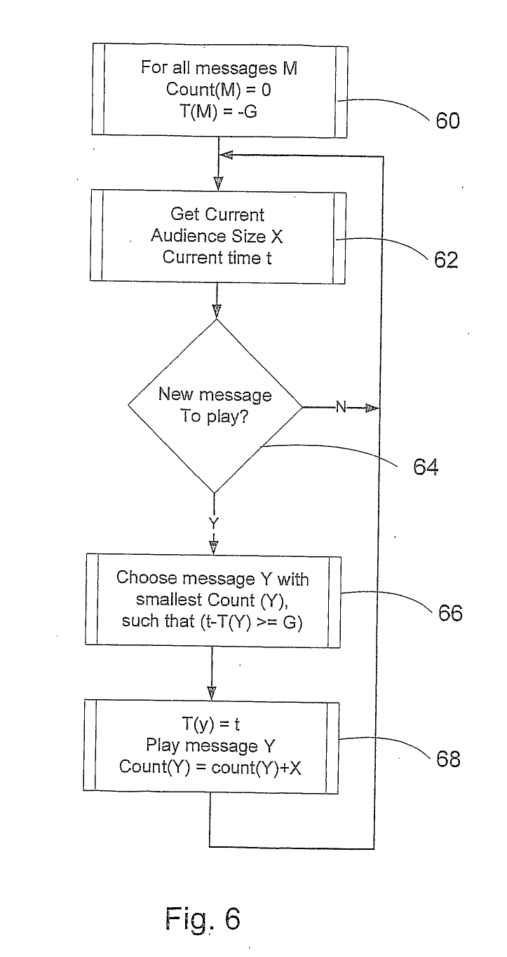

FIG. 6 is a flow chart of another method for rescheduling playback of messages from a master playlist according to embodiments of the present invention, which is a modified version of the message selection method described in FIG. 5. The audience-adaptive rescheduler selects the next message Y with smallest viewers Count(Y) of those messages that have not yet played for at least time G, where G is a minimum period of time. This means that for a chose time gap the message that was just played will not be repeated and one or more other messages from the playlist will play in that time gap.

According to another embodiment of the present invention, at least a subset of the set of messages is targeted towards certain demographics of the audience and the message effectiveness is related to such demographics. In an example, a message is targeted towards female shoppers. In another example, the message is targeted towards young adults. In such cases only viewers of certain demographics are qualified to count as qualified viewers per a specific message, and the message Utility is equal to the number of such viewers.

To select a message based on current audience demographics, the Audience Tracker must produce Audience Vectors that comprise at least the required demographics. In addition, at least a subset of the messages in the playlist must be tagged with target audience vectors for said messages, or alternatively tag a message as targeting all audience demographics.

As two different messages may be targeted to viewers of different demographics, the same audience may yield different Utility values for these messages. For example, if at a certain time there are three males and two females watching the display, then the Utility of all messages with male target audience is 3 and the Utility for all messages with female target audience is 2.

It is known to select the message with largest Utility from a set of messages, based on audience demographics. According to known media selection techniques the same message will be played again and again for audience of the same composition.

The message rescheduling methods described in FIG. 5 and FIG. 6 can be further modified to balance the number of qualified viewers.

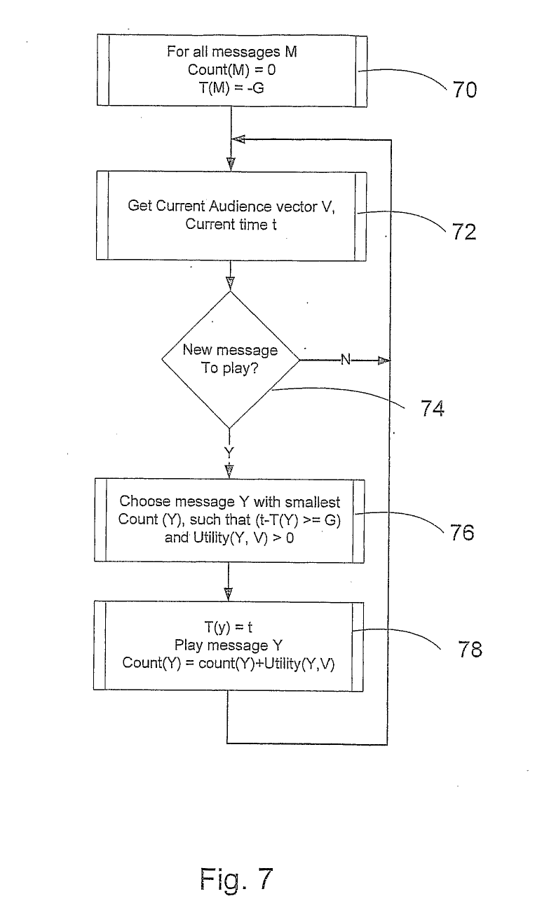

FIG. 7 is a flow chart of another algorithm for rescheduling playback of messages from a master playlist according to embodiments of the present invention subject to a minimum gap constraint. The audience-adaptive rescheduler, after initial reset (70) will periodically obtain the current audience vector and current time (72) and upon determining whether to play a new message (74) will select the next message Y with smallest Count(Y) of those messages with Utility(Y) >0 that have not played for at least time G, where G is the minimum time gap (76). Count(Y) is incremented by the Utility(Y) which is the number of qualified viewer as obtained from the audience demographics. Then the message count will be updated (78).

A rescheduling method as described in FIG. 7 is aimed at balancing the number of qualified viewers among all messages, but may be ineffective in terms of the message playing device utilization. For example: if at a given time there are 1 male and 10 females watching a display, and the message with lowest Count(Y) is male-targeted than it will be played although it may be more efficient to choose a female targeted one.

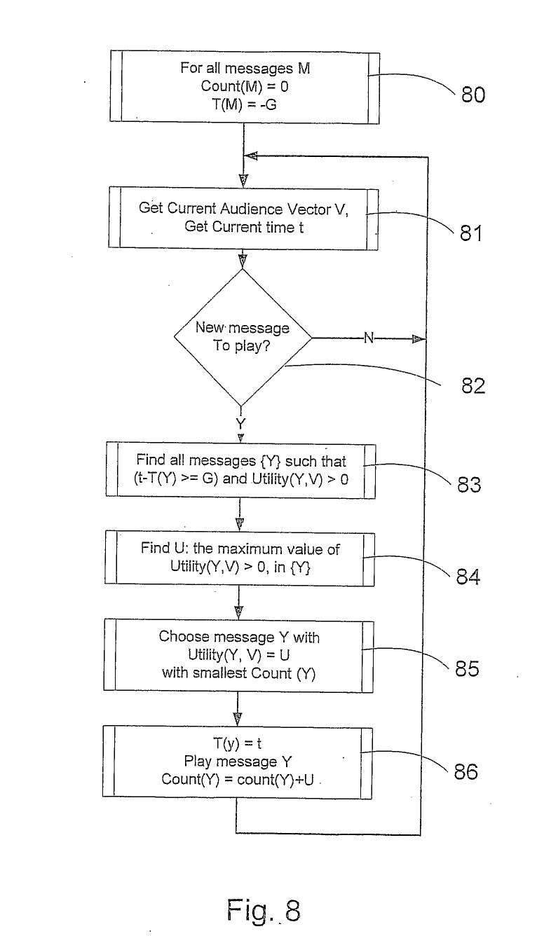

FIG. 8 is a flow chart of another method for rescheduling message playback according to embodiments of the present invention, for increasing display effectiveness by selecting the message with largest Utility.

The method described in FIG. 8 seeks to increase the display effectiveness by selecting the message with largest Utility, thereby maximizing the number of qualified viewers addressed in total. This method is aimed at balancing the number of qualified viewers for advertisements with the same target audience. After resetting count and setting time G (80), current audience vector V and time t is periodically obtained (81), whenever a new message is required for playing (82), messages such that t-T(Y) is equal or is greater than G, and Utility (Y,V) is greater than zero are considered (83). Then audience vector V is used to find the largest Utility U among all messages, for that vector (84). The message Y with smallest Count(Y) is selected (85) among all messages with Utility U and played (86). Count(Y) is incremented by U.

For example, in the case of sporting apparel branded shop, the master play-list may comprise multiple messages targeted towards female audience and also of multiple message targeted towards male audience. According to the present invention as depicted in FIG. 8, while a female majority audience is facing the display, the female-targeted messages will be selected, in a manner that balances qualified (female) viewership, subject to minimum time gap constraint, and similarly for a male majority audience. Ties can be broken arbitrarily.

While maximizing the display effectiveness, certain messages may seldom or never play. For example, if females are always a majority, messages with male target audience will never play. As another example, if two or more ads are targeted towards the general audience (Utility equals audience size), they will always play, blocking any messages targeted towards specific audiences.

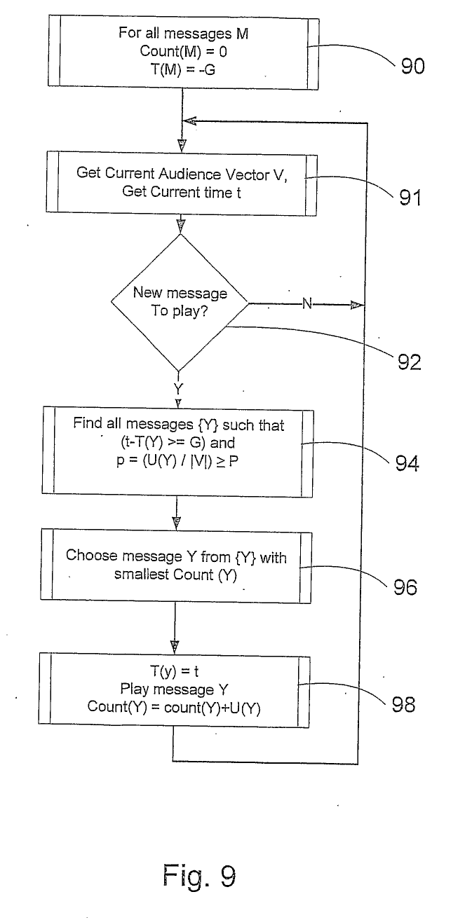

FIG. 9 is a flow chart of another method for rescheduling message playback according to embodiments of the present invention that balances between the display effectiveness in terms of the number of qualified viewers addressed and the messaging effectiveness in terms of number qualified viewers addressed per message. A message is defined as having valid-target-audience with respect to an audience vector if at least P percent of the audience members match the message target audience. Example: if current audience vector is {male, Asian}, {male, Caucasian}, {male, Asian}, {female, Asian}, {female, Caucasian} and P=50%, than the audience is valid with respect to messages with male target audience as well as messages with Asian target audience.

Accordingly, initially, all counts are reset (90) and current audience vector and time are periodically obtained (91).Whenever a message is to be played (92), audience vector

V is compared with all messages that have not played longer than the predefined time gap, to find (94) all messages {Y} with valid target audience, as defined by the constraint:

$$p ( Y ) = \frac{U ( Y )}{\vert V \vert} \geq P$$

where U(Y) is the Utility of Y or the number of qualified viewers for message Y and |V| is the audience size. The normalized audience matching score p(Y) is compared with the matching threshold P. Among all messages in {Y} that satisfies the constraint above, the algorithm finds the message Y with lowest Count(Y) (96), which is then increased by U(Y) (98). Thus, the algorithm balances viewership for all advertisements by their target audience, while increasing the display effectiveness by at least P% of the current audience size. Still, a disadvantage of this algorithm is that a message that does never matched the audience vector at P% or more, shall never play.

Thus, it may be advisable to modify the target-audience-adaptive scheduling methods according to embodiments of the present invention by additional methods that will balance further the playback of messages and other content. According to one such modification, the master playlist shall be fully executed at each playback cycle, by excluding the played messages from further playback until the entire playlist has been fully executed. In the case that none of the remaining messages satisfies the constraints according to the adaptive scheduling methods, one of said remaining messages is arbitrarily chosen. Such a method guarantees that the master playlist is indeed executed as planned and each message is played exactly the planned number of times. However, consider the case where one specific message is targeted towards a specific target audience (young males) and such audience is indeed facing the display. The message will play, but then will wait until the end of the master playlist, by which time the specific audience is gone and may not be present again for some time. The method above can be improved by creating a “Super playlist” comprising of M times the master playlist. The Super playlist allows a message to repeat before all other messages have been played, and yet maintains a fixed number of plays for each message.

According to another such modification, the messages controlled by one of the methods mentioned hereinabove are interleaved with messages played in order and other messages.

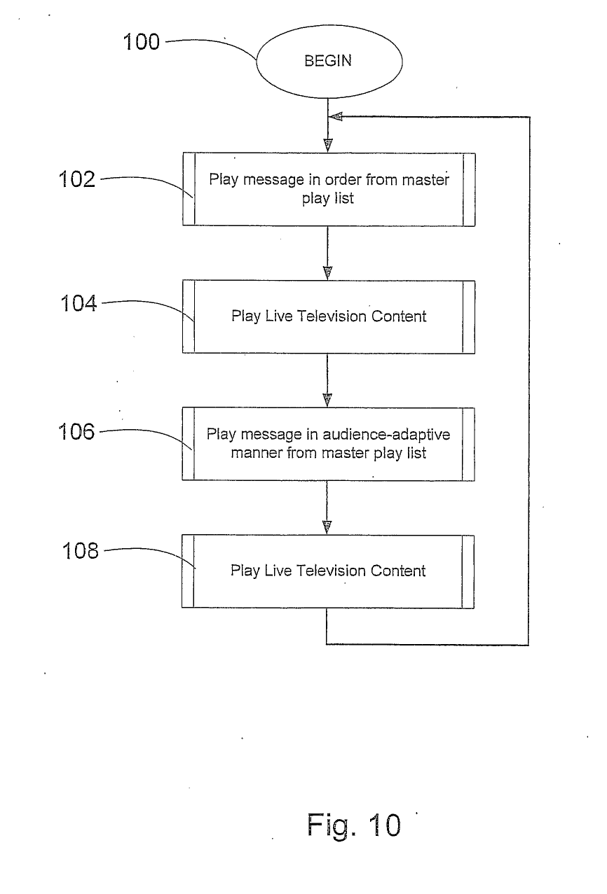

FIG. 10 shows a flow chart of such interleaving of messages from the master play-list and live television content that serves as a filler, draws viewer attention to the screen, and maintains a minimum time gap between consecutive plays of the same message. In such a manner each message is guaranteed to play at least once during a full cycle, as determined by the length of the play list, while a comparable proportion of display time is allocated to audience-adaptive message display. After the begin command (100) messages are played in a predetermined order from the master playlist (102). Live TV content is played (104) and message from the master playlist is interleaved according to one of the embodiments of the present invention (106), After that message live TV content is commenced (108).

According to another such modification, messages selected in one of the selection methods according to embodiments of the present invention are displayed concurrently with messages played in order and other messages. For example, while the primary video content is played in order or as scheduled, the messages controlled by one of the methods mentioned hereinabove are displayed as a ticker, banner, or semi-transparent overlay on the primary video content.

The methods described above are suitable for non-revenue based message displays, such as a private display network in a store of a sporting brand, promoting the products of that brand, or a corporate display network addressing employees and guests.

The methods can be easily be adapted to revenue-based advertising applications and allow for charging the advertiser per the number of qualified viewers, as defined by the message Utility, according to embodiments of the present invention.

The number of qualified viewer may be included in a display log file and passed to a suitable billing system for submitting the charge to the advertisers.

Such an arrangement may be highly desirable by advertisers as they pay for actual exposure of their message to the desired target audience, and by display network as that may succeed in attracting more advertisers and negotiating higher prices for their network. However, such a model may introduce advertising charges that exceed a pre-allocated budget.

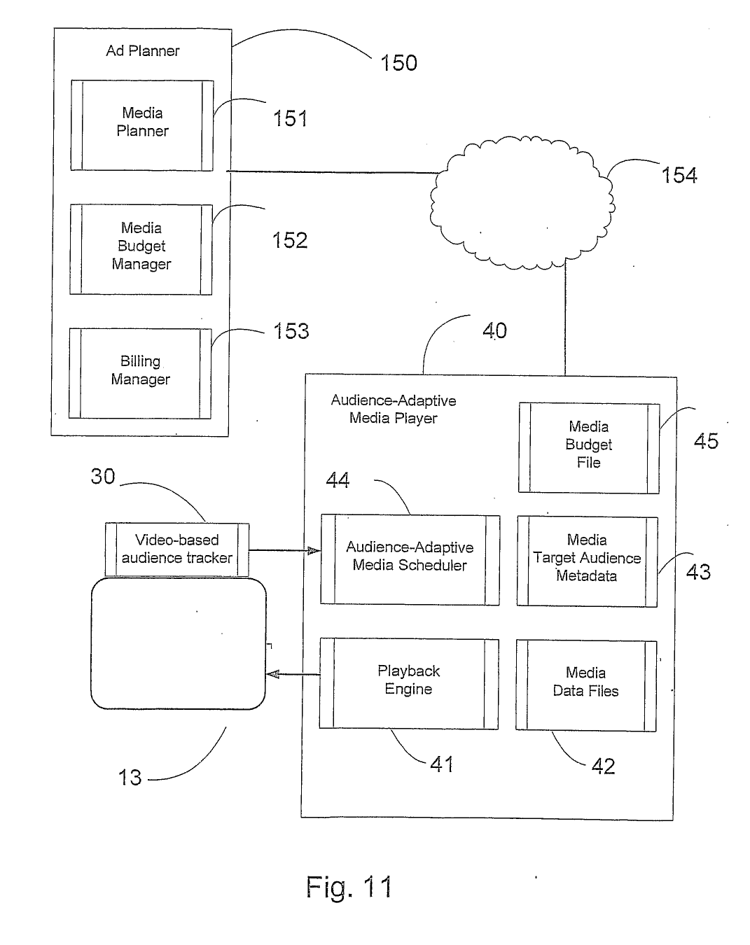

According to one embodiment of the present invention, a method for budget-limited adaptive message display is provided, by incorporating a Media Budget File module into each Media player, as described in FIG. 11. With a “price-per-qualified-viewer” model, the Budget File maintains the number of qualified viewer initially allocated or purchased per message and then updates that number per the exposure to qualified viewers.

As these modules are incorporated with the Audience Adaptive Media Player 40, Player 40 may implement the audience-adaptive scheduling methods according to embodiments of the present invention, without wide-area network connectivity, as its communication with the Audience tracker 30 may be maintained over local area network, or maintain communication over a network 154 with Ad Planner 150. Ad Planner 150 comprises a Media Planner module 151, which may implement a method for selecting a message to play from a message playlist, according to embodiments of the present invention, Media Budget Manager module 152, which can be used to save budget information pertaining to each of the messages on the playlist issue a clear command allowing playing of a message from the playlist if a budget was confirmed and a halt command preventing playing of a message if the budget was consumed, and Billing Manager module 153 to manage billing of customers, based on an agreed billing schedule.

During media planning, Media Budget Manager 152 allocates qualified viewer budget unit per Media Player 40. For example, an advertising campaign on out-of-home display is budgeted at $5,000 daily. With 5c per qualified viewer, 100,000 units are available daily. If the budget is evenly allocated across 200 displays in the target market, then a budget of 500 qualified viewers per day is allocated and stored in the Media Budget File for that specific message.

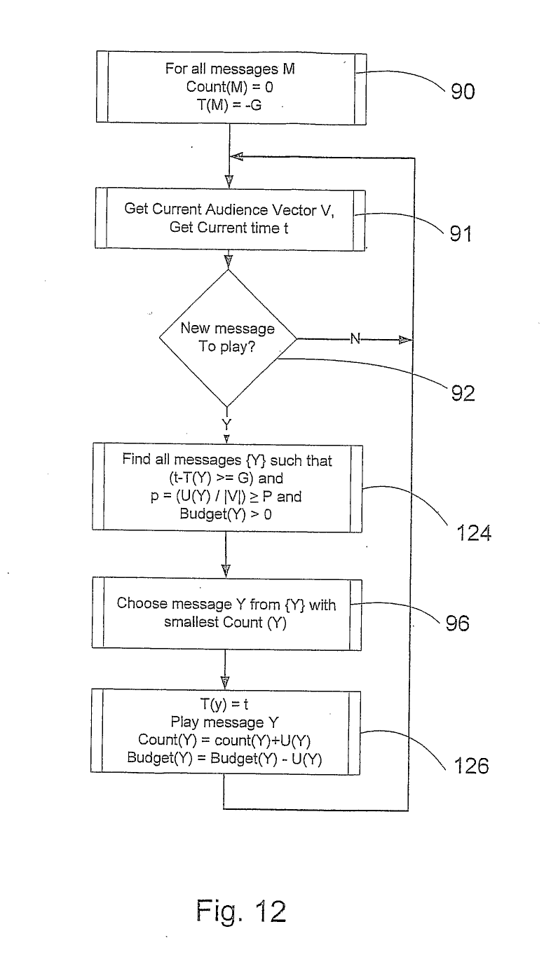

FIG. 12 describes a budget-limited audience adaptive rescheduling method according to embodiments of the present invention, where the budget constraint is applied to the method described in FIG. 9. This constraint can be applied similarly to other audience-adaptive scheduling methods, according to the present invention.

In FIG. 12, only messages with positive budget are considered for play in 124, and when selected, their budget is decremented by the utility U(Y), in 126. The method can be readily modified to master playlists comprising of advertisements and other messages by checking for remaining budget and then updating the budget of the selected messages only for the revenue-oriented messages, and proceeding as before with the non-revenue oriented messages.

The description above assumes a uniform charge token, which is a number of qualified viewers. Correspondingly, the budget for a selected message Y is decremented by U(Y). Additional pricing models can be readily implemented by assigning budget in monetary values and other utility and charge functions that depend on the size of current audience, the number of qualified viewers within the audience, etc. For example, one may assign a cost unit to a qualified viewer and a fraction of a cost unit to any other viewer.

The Media Players according to embodiments of the present invention are accessed by the ad campaign manager system over the network 54 from time to time, in order to query the current Utility values obtained for each message. Such values are input to the Billing Manager 53 to generate charges per message. Additionally, such query may exhibit the under utilization of a certain budget allocated to a message. For example a message targeted towards young viewers is underutilized at a location which is not attractive for young people. Alternatively, a certain message may have exhausted its budget. In both these cases the Media Planner system may generate suitable alerts to the advertising agency or any other entity controlling the advertising budget, to direct additional budgets to or from specific message, or shift such budget between locations.

According to FIG. 4, an Audience Tracker is assigned to each display to be controlled according to embodiments of the present invention. In some applications several displays are placed closely together for increasing the impact of message display. When close enough such as in the case of a “video wall” arrangement, a single Audience Tracker may be used to cover the entire audience area for the arrangement of displays.

When several displays are configured to display the same message, they may be considered as a single display. However, when different adjacent screen display different messages, the Audience Tracker may be modified to identify the specific portion of the audience that look at a specific display or subset of displays. According to embodiments of the present invention each display in the subset of displays corresponding to said specific portion is controlled according to the present invention in a manner adaptive to said specific portion.

The present invention has been described in the context of out-of-home multimedia display system. However, it is apparent that the present invention may be applied also to other venues, for example in-home message/ad delivery. Currently, advertising is interleaved with television programming to meet regulations and keep audience interest. Currently, broadcast systems are designed to insert local advertising at the cable head end, thereby targeting local audience with advertisements of local interest.

Furthermore, broadband content delivery systems according to prior art are designed to deliver targeted content per household profile of interest, as obtained from viewing habits and other profiling data. However, such systems are incapable of delivering content that is targeted towards the current viewers.

Known techniques of audience tracking such as the ones described above or different real-time audience tracking techniques can be used in-home to provide the audience vector, and the suitable message or advertisements are selected according to the present invention. For in-home applications, the content management server may be at the cable head end and the player may be the set-top-box receiver. Selected informational messages may be transmitted to the player in real-time or may be downloaded and stored on the player. According to one embodiment, the stored informational messages are the same for all homes, while their play is controlled according to the present invention. According to another embodiment, the stored informational messages are selectively downloaded based on the household demographics and other indicators of topics of interest, and the play of said messages is again controlled according to the present invention.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A method for selecting at least one message from a playlist including a plurality of messages to be played by a message playing device to an exposed audience, each message directed to a target audience, the method comprising:
choosing a utility function, depending on one or more audience parameters, for each of the plurality of messages;
periodically measuring said one or more audience parameters pertaining to the exposed audience;
calculating utility for each of the messages from the playlist using the utility function, based on said one or more audience parameters as periodically measured; and
selecting a message to play from the playlist based on a cumulative gain attributed to each message from the playlist that has played, wherein the gain is updated with respect to the calculated utility for that message.

2. The method as claimed in claimed in claim 1, wherein the step of selecting a message to play from the playlist is also based on the calculated utility for each of the messages from the playlist.

3. The method as claimed in claim 1, wherein the gain is calculated with respect to one ore more parameters selected from a group of parameters including: count of members of the exposed audience, count of select members of the exposed audience, exposure time of a message from the playlist to members of the exposed audience, exposure time of a message from the playlist to select members of the exposed audience, distance of members of the audience from the message playing device, financial revenue obtained for playing a message from the playlist.

4. The method as claimed in claim 1, wherein the utility function depends on one ore more parameters selected from a group of parameters including: count of members of the exposed audience, count of select members of the exposed audience, exposure time of a message from the plurality of messages to members of the exposed audience, exposure time of a message from the plurality of messages to select members of the exposed audience, financial revenue obtained for playing a message from the plurality of messages.

5. The method as claimed in claim 1, wherein a message from the plurality of messages that has played is ignored for a predetermined duration of time when performing the step of selecting the message to play.

6. The method as claimed in claim 1, wherein the step of selecting the message to play comprises selecting a message for which the cumulative gain is smaller than the cumulative gain of other messages from the playlist.

7. The method as claimed in claim 6, wherein the step of selecting the message to play comprises selecting a message for which the cumulative gain is the smallest of the cumulative gain of other messages from the playlist.

8. The method as claimed in claim 6, wherein the step of selecting the message to play comprises selecting a message for which the utility is greater than zero.

9. The method as claimed in claim 6, wherein the step of selecting the message to play comprises selecting a message for which the utility is greatest.

10. The method as claimed in claim 1, wherein said one or more measured audience parameters pertaining to the exposed audience are indicative of presence of at least a predetermined percentage of the target audience in the exposed audience.

11. The method as claimed in claim 1, further comprising playing additional content interleaved between played messages from the playlist.

12. The method as claimed in claim 1, further comprising playing additional content and messages from the playlist concurrently.

13. The method as claimed in claim 1, further comprising ignoring a message from the playlist for which a predetermined budget has been consumed in the step of selecting the message to play.

14. A system for selecting at least one message from a playlist including a plurality of messages to be played by a message playing device to an exposed audience, each message directed to a target audience, the system comprising:
an input interface for choosing a utility function, depending on one or more audience parameters, for each of the plurality of messages;
an audience tracker for periodically measuring said one or more audience parameters pertaining to the exposed audience; and
a processor for calculating utility for each of the messages from the playlist using the utility function, based on said one or more audience parameters as periodically measured, and for selecting a message to play from the playlist based on a cumulative gain attributed to each message from the playlist that has played, wherein the gain is updated with respect to the calculated utility for that message.

15. The system as claimed in claim 14, wherein the audience tracker comprises an imaging device.

16. The system as claimed in claim 14, comprising a budget manager module to issue a clear command allowing playing of a message from the playlist if a budget was confirmed and a halt command preventing playing of a message if the budget was consumed.

17. The system as claimed in claim 14, comprising a billing module.
